(19) United States
(12) Patent Application Publication
(10) Pub. No.: US 2026/0165309 A1
(43) Pub. Date: Jun. 18, 2026

(54) CHEMICAL TREATMENT DELIVERY DEVICE

(71) Applicant: JVD, INC., Scotts Valley, CA (US)

(72) Inventors: Michael L. VANDIERENDONCK, Scotts Valley, CA (US); Ronald POWERS, Ben Lomond, CA (US)

(21) Appl. No.: 19/416,596

(22) Filed: Dec. 11, 2025

Related U.S. Application Data
(60) Provisional application No. 63/733,801, filed on Dec. 13, 2024.
(60) Provisional application No. 63/765,111, filed on Feb. 28, 2025.

(51) Int. Cl. A01M 1/20

(52) U.S. Cl. CPC A01M 1/2016; A01M 2200/012

(57) ABSTRACT

Embodiments of the present disclosure generally relate to devices for controlled release of chemicals. In one embodiment, an apparatus is provided including a housing having an upper end and a lower end, one or more apertures disposed through the housing from the upper end to the lower end, a stopper disposed at one or more of the lower ends of the one or more apertures, an ejection device assembly disposed in one or more of the one or more apertures adjacent the stopper, wherein each stopper being ejectable under force using each ejection device assembly.

### CROSS-REFERENCE TO RELATED APPLICATION

This application claims priority to and the benefit of U.S. Provisional Ser. No. 63/733,801 , filed Dec. 13, 2024, and U.S. Provisional Ser. No. 63/765,111 , filed Feb. 28, 2025, which applications are incorporated by reference herein in its entirety.

### BACKGROUND

### Field

Embodiments of the present disclosure generally relate to devices for controlled release of a chemical, in particular, for controlled release of chemical for the mitigation of insects and pest and/or storage of chemical management information.

### Description of Related Art

Mosquitoes pose significant and dire health threats to humans due to their ability to spread disease. Mosquitos breed in bodies of water, such as ponds and lakes, and in agricultural settings, in livestock water troughs and other artificial water retention structures. However, current systems to control mosquitoes require environmental spraying or the use of mosquito attracting lighting. Such spraying can be wasteful and environmentally damaging. The lighting devices are not practical in many applications, such as in large scale usage around bodies of water.

Thus, there is a need in the art for improved chemical delivery devices that reduce waste and environmental consequences.

### SUMMARY

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

Embodiments of the present disclosure generally relate to devices for controlled release of chemicals, in particular, for controlled release of insecticides, supplements, biological agents, medicines, and/or storage of management information.

In one embodiment, an apparatus is provided including a casing body having a first body end and a second body end, one or more chambers disposed within a portion of the casing body at a first body end, each of the one or more chambers having a first chamber end disposed in the first body end and a second chamber end comprising a driver recess, a stopper disposed at each of the first chamber end of the one or more chambers, and an ejection device assembly disposed in the casing body in the second body end and at the second chamber end of the one or more chambers, wherein each stopper being ejectable under force using the ejection device assembly.

In one embodiment, a method for operating an apparatus including providing a device including a casing body, one or more chambers disposed within a portion of the casing body at a first body end, a stopper mounted on each of the one or more the one or more chambers, and an ejection device assembly comprising a compressed spring, a clamping ring disposed around the compressed spring, and a heating element holding close the clamping ring, applying a power to the heating element and releasing the clamping ring, decompressing the spring, moving one of the one or more chambers with the spring, and ejecting the stopper from the first end of the one of the one or more chambers.

In one embodiment, a ruminant bolus delivery device is provided including a cylindrical body and one or more chambers within the cylindrical body, each of the one or more chambers containing a stopper at an end thereof, the stopper being ejectable under force using a spring assembly

In one embodiment, an apparatus is provided including a housing having an upper end and a lower end, one or more apertures disposed through the housing from the upper end to the lower end, a stopper disposed at one or more of the lower ends of the one or more apertures, an ejection device assembly disposed in one or more of the one or more apertures adjacent the stopper, wherein each stopper being ejectable under force using each ejection device assembly. The apparatus may further include an electronic assembly disposed at the upper end of the housing, and the electronic assembly contacts each ejection device assembly.

In one embodiment, a method for operating an apparatus including providing a device including a housing having an upper end and a lower end, at least one aperture disposed through the housing from the upper end to the lower end, a stopper disposed at one or more of the lower ends of the at least one aperture, an ejection device assembly disposed in the at least one aperture adjacent the stopper, wherein each stopper being ejectable under force using each ejection device assembly, and an ejection device assembly comprising a chamber a spring assembly disposed adjacent the chamber, the spring assembly comprising at least a a spring defining a gap therein, a spring mount disposed inside at least a portion of the gap, a clamping ring disposed around a portion of the spring, and adapted to hold the spring in a compressed state and a heating element coupled to the clamping ring, applying power to the heating element and releasing the clamping ring, decompressing the compressed spring and the spring mount, contacting the chamber with the spring mount, and ejecting the stopper from the aperture.

In one embodiment, a submersible dispensing system, including a cylindrical body and one or more chambers disposed within the cylindrical body, each of the one or more chambers containing a stopper at an end thereof, the stopper being ejectable under force using a spring assembly

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A-1C are side, back end, and front-end views of a device according to certain embodiments;

FIG. 2 is a sectional view along of the device along Line A-A of FIG. 1B according to certain embodiments;

FIG. 3 is an isomeric view of the device with a transparent cylindrical body according to certain embodiments;

FIGS. 4A and 4B are side and back end illustrating stopper separation according to certain embodiments;

FIG. 5 is a sectional view along of the device along Line A-A of FIG. 4B according to certain embodiments;

FIGS. 6A and 6B are detailed portion view of Sections B and C of FIG. 5, according to certain embodiments;

FIG. 7 is an exploded side view of the device according to certain embodiments;

FIG. 8A is an exploded isometric view of the device according to certain embodiments;

FIG. 8B is a top down view of a spring assembly according to certain embodiments;

FIG. 9 is another exploded isometric view of the device according to certain embodiments;

FIGS. 10A-10C are side view, back isometric view, and front isometric views of a device according to certain embodiments;

FIG. 11 is an exploded side view of the device according to certain embodiments;

FIG. 12 is a exploded front isometric view of the device according to certain embodiments;

FIG. 13A is a side view of a device according to certain embodiments;

FIG. 13B is a sectional view along of the device along Line A-A of FIG. 13A according to certain embodiments;

FIG. 14 is an exploded side view of another device according to certain embodiments;

FIG. 15 is a schematic side view of one application of the device according to certain embodiments;

FIG. 16 is a schematic side view of one application of the device according to certain embodiments;

FIG. 17 is a side view of the device according to certain embodiments; and

FIG. 18 is schematic side view of the device according to certain embodiments.

To facilitate understanding, identical reference numerals have been used, where possible, to designate identical elements that are common to the figure. It is contemplated that elements and features of one embodiment may be beneficially incorporated in other embodiments without further recitation.

### DETAILED DESCRIPTION

Embodiments of the present disclosure, examples of which are depicted in the attached Figures, relate to an improved dispensing system, which may be submersible. More specifically, embodiments of the present disclosure relate to devices for controlled release of chemical agents, such as insecticides, that may be submersible in liquid environments or used in atmospheric environments. Certain details are set forth in the following description and figures to provide a thorough understanding of various implementations of the disclosure. Other details describing well-known methods and systems often associated with the deposition of material layers are not set forth in the following disclosure to avoid unnecessarily obscuring the description of the various implementations.

Many of the details, components and other features described herein are merely illustrative of particular implementations. Accordingly, other implementations can have other details, components, and features without departing from the spirit or scope of the present disclosure. In addition, further implementations of the disclosure can be practiced without several of the details described below.

Embodiments of the present disclosure include dispensing devices in which the end stoppers may be ejected, which may be submersible.

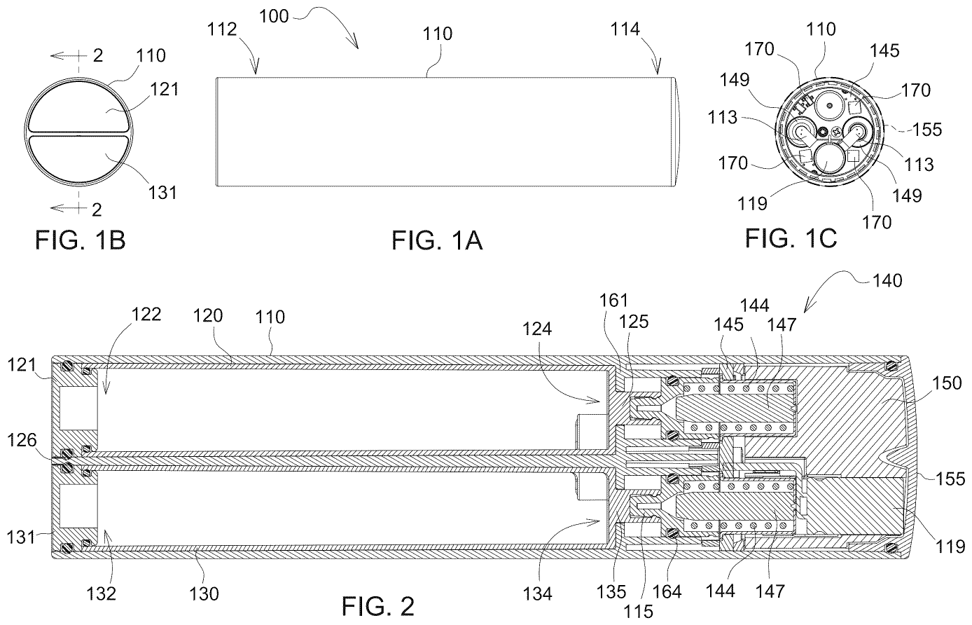

An exemplary embodiment is shown in reference to FIGS. 1-9 using two chambers, however, it is contemplated that different number of chambers may be used, and following description is provided for illustrative purposes.

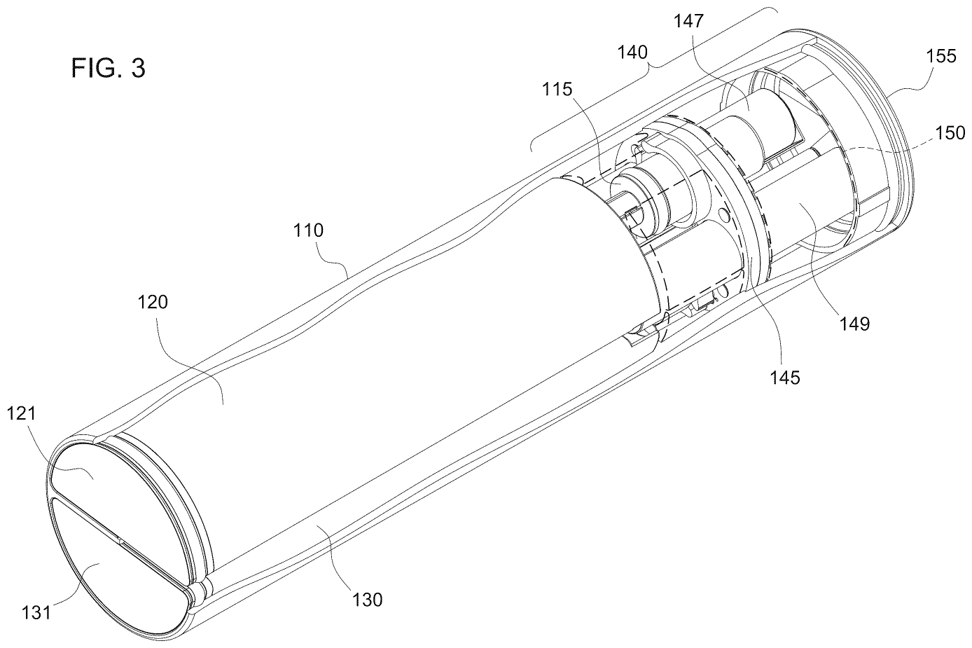

Referring to FIGS. 1A-1C, 2, 3, and 4B, one embodiment of the of the device will be described. FIGS. 1A-1C are side, back end, and front end views of a device 100 according to certain embodiments. FIG. 2 is a sectional view along of the device along Line A-A of FIG. 1B. FIG. 3 is an isomeric view of the device with a transparent cylindrical body.

The device 100 includes a casing body 110, one or more chambers, such as first chamber 120 and second chamber 130, one or more stoppers, such as stoppers 121 and 131, and an ejection device assembly. When assembled the device 100 is sealed from fluids, such as air and water. In one embodiment, the sealed device may be considered waterproof. While removal of one of the stopper may result in a fluid entering a chamber, the remaining device is sealed from fluids. The sealed devices allow the devices to be used in liquid environments for extended periods of time.

The casing body 110 has a first body end 112 and a second body end 114. The casing body 110 may be in the form of a cylinder or tube. Alternatively, the casing body 110 may be in the form of other geometric shapes as needs for application purposes, such as cones, cubes, cuboids, among others. The casing body 110 may be made of a water-resistant and/or corrosion resistant material. Suitable casing body 110 materials may be selected from the group of plastic, metal, or combinations thereof. If the casing body 110 material is plastic, the casing body 110 may be made of a transparent or translucent material.

The casing body 110 may optionally include a casing body support 161. The casing body support 161 is disposed on an inner circumference of the casing body 110 and may be located between the chambers 120, 130 and an ejection device assembly 140. The casing body support 161 is used for aligning the components of the system as well as used with the chamber separator 126 for aligning the chambers 120, 130 with the ejection device assembly 140.

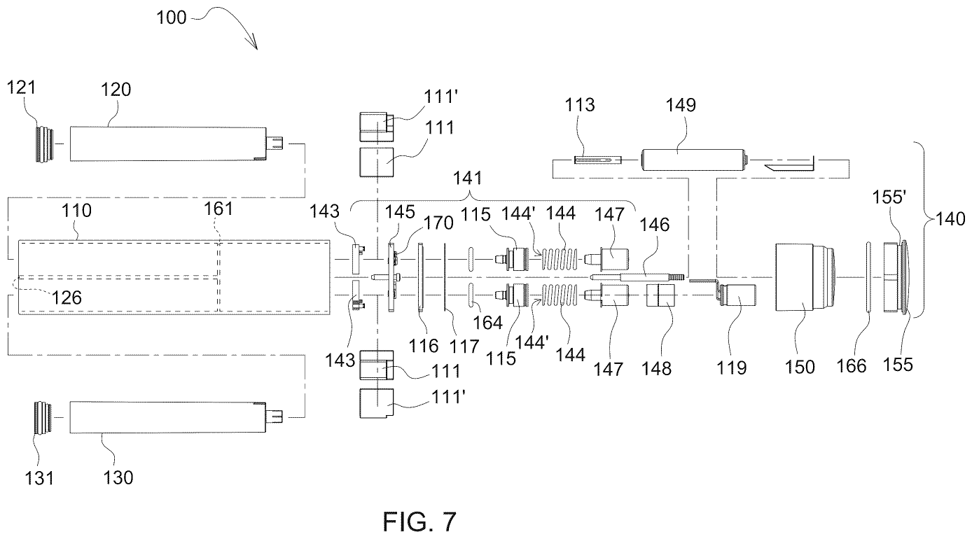

Ejection device assembly spacers may be disposed in the casing for aligning and supporting the chambers 120, 130 with the ejection device assembly 140. Referring to FIGS. 7-9, the device 100 may further include weights to provide desired buoyancy in fluid, such as water or animal organs, such as stomachs. The weights may also prevent premature removal if used in animals, for example rumen retention. Weights may be used as upper weights 111 and lower weights 111′ are shown. The weights may be made from any suitable material, such as metals, that provide a desired weight for the device 100. Alternatively, if plastic or other light weight material is used instead of weights, a device 100 may instead have upper ejection device assembly spacers 111 and lower ejection device assembly spacers 111′ are shown.

Also, referring to FIGS. 7-9A, the casing body support 161 may be adapted to be a component receiving holder. Upper weights 111 and lower weights 111″ may also be adapted with the casing body support 161 for receiving and supporting components of the ejection device assembly 140. The casing body support 161 may be adapted to align with the shaped holder 150 or be adapted to interconnect with the shaped holder 150. The casing body support 161 may be a metal or plastic, and may be the same material as the shaped holder 150.

Embodiments of the present disclosure may include one chamber or a plurality of chambers disposed within a portion of the casing body 110, for example, two chambers or three chambers.

As shown in FIGS. FIGS. 1A-1C, 2, and 3, a first chamber 120 and a second chamber 130, are disposed in the casing body 110 in a parallel manner with a first chamber end 122 disposed toward or at first body end 112 of the casing body 110. The chambers 120, 130, may be in the shape of a semicylinder for a cylinder or tube shaped casing body 110. The chambers may be of any geometric shape needed to be positioned inside the shape of the casing body 110. The chambers may be hollow chambers or may have shaped interiors. The chambers are configured to hold chemical materials, such as supplements or medicines.

The chambers may be separated by a chamber separator 126 disposed between the chambers. The chamber separator 126 may be used for aligning the chambers with the ejection device assembly as well as providing support during use. The chamber separator 126 may comprise part of the casing body support 161.

Each chamber includes a first chamber end and a second chamber end. The first chamber end comprises a partial or full opening, and a stopper may be disposed in and sealing the opening. The second chamber end is disposed towards an ejection device assembly. The second chamber end comprises a driver recess to receive a driver from the ejection device assembly.

As shown in FIG. 2, the first chamber 120 includes a first chamber end 122 and a second chamber end 124. The first chamber end 122 comprises a partial or full opening 123, and a stopper 121 may be disposed in and sealing the opening 123. The stoppers are disposed in a manner with each stopper being ejectable under force using the ejection device assembly 140. Once a stopper is removed or ejected from a chamber, any chemical material disposed in the chamber may be dispersed or ejected into the surrounding environment.

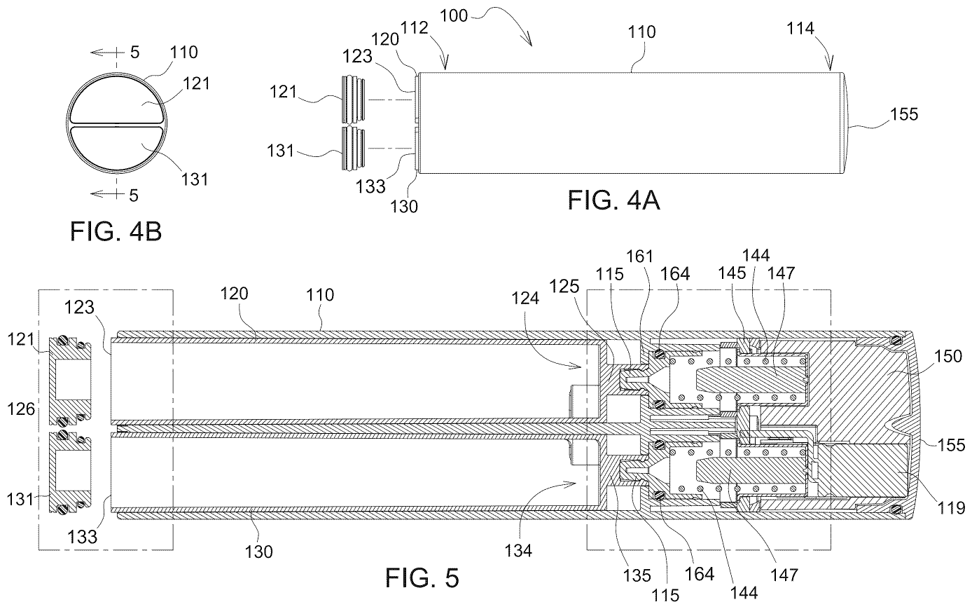

FIGS. 4A, 5, and 6A illustrate the device with stoppers 121 and 131 not disposed in the respective chambers 120, 130. As shown in the figures, the stoppers 121, 131, may further include one or more o-rings, for example o-rings 121′, 121″, 131′, and 131″, for forming a seal with the respective chambers.

The second chamber end 124 is disposed towards an ejection device assembly 140. The second chamber end 124 comprises a driver recess 125 to receive a driver 115 from the ejection device assembly. The second chamber 130 includes a first chamber end 132 and a second chamber end 134. The first chamber end 132 comprises a partial or full opening 133, and a stopper 131 may be disposed in and sealing the opening 133. The second chamber end 134 is disposed towards an ejection device assembly 140. The second chamber end 134 comprises a driver recess 135 to receive a driver 115 from the ejection device assembly. A driver o-ring 164 may be used to help prevent fluids from entering the driver section and ejection device assembly 140, including electrical components, and may also secure the driver 115 in the ejection device assembly 140.

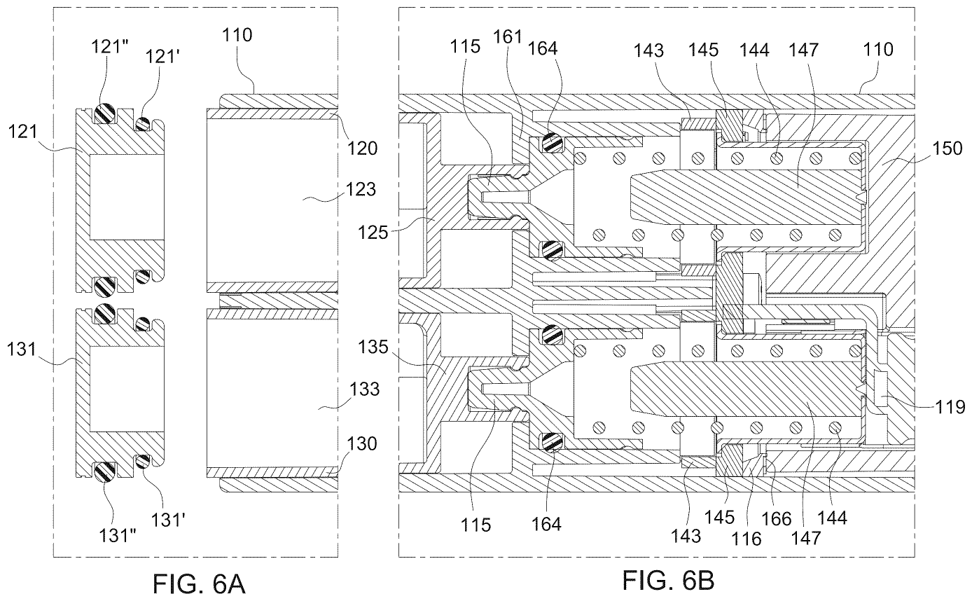

Referring to FIGS. 6B, 7, 8A-8B, and 9, the ejection device assembly 140 is disposed in the casing body 110 in or towards the second body end 114 at the second chamber ends of the one or more chambers.

The ejection device assembly includes an electronic assembly 145, a spring assembly 141 disposed through the electronic assembly 145, and at least one power source 149 coupled to the spring assembly 141.

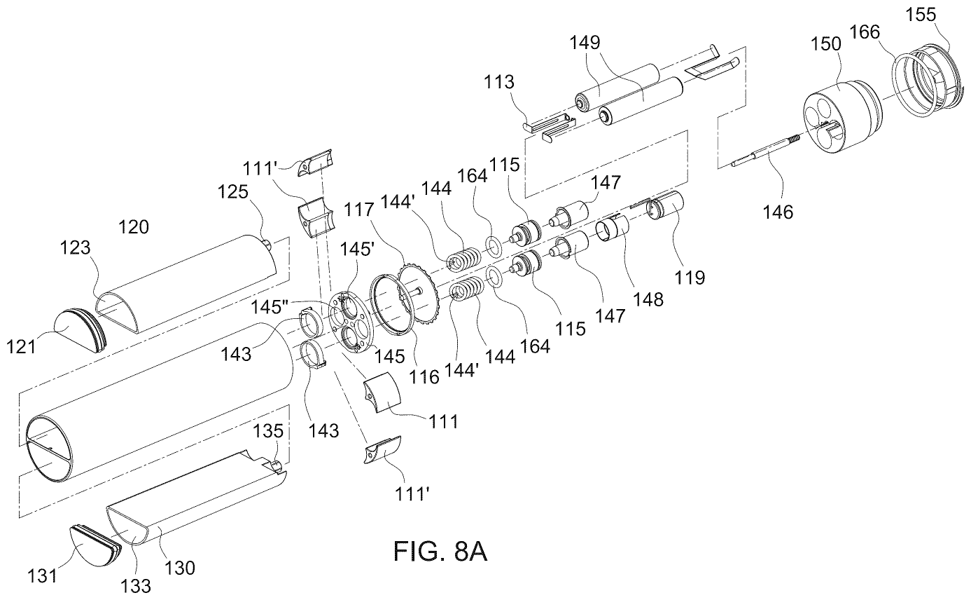

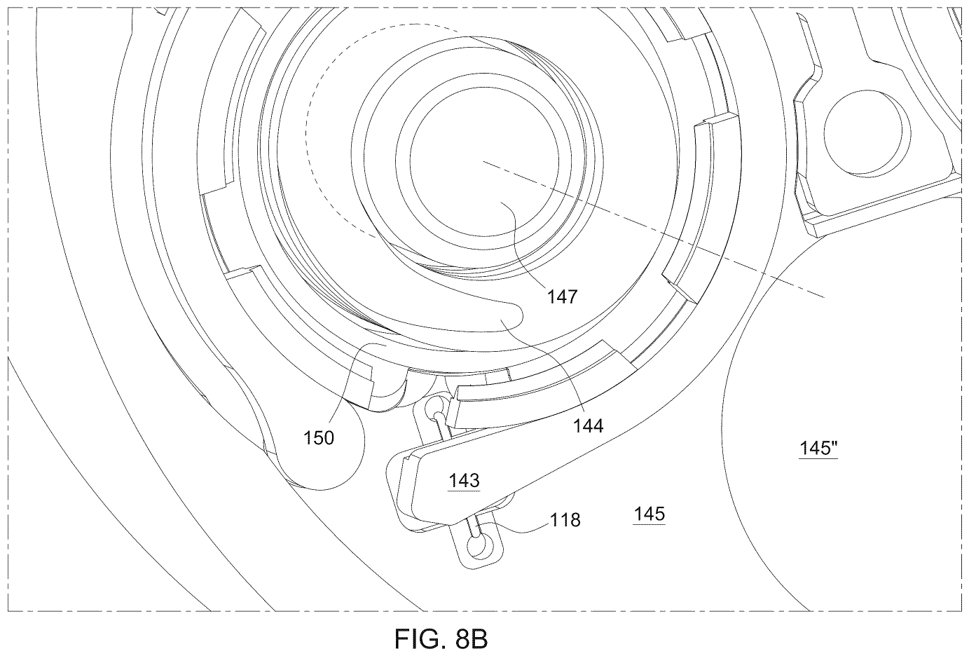

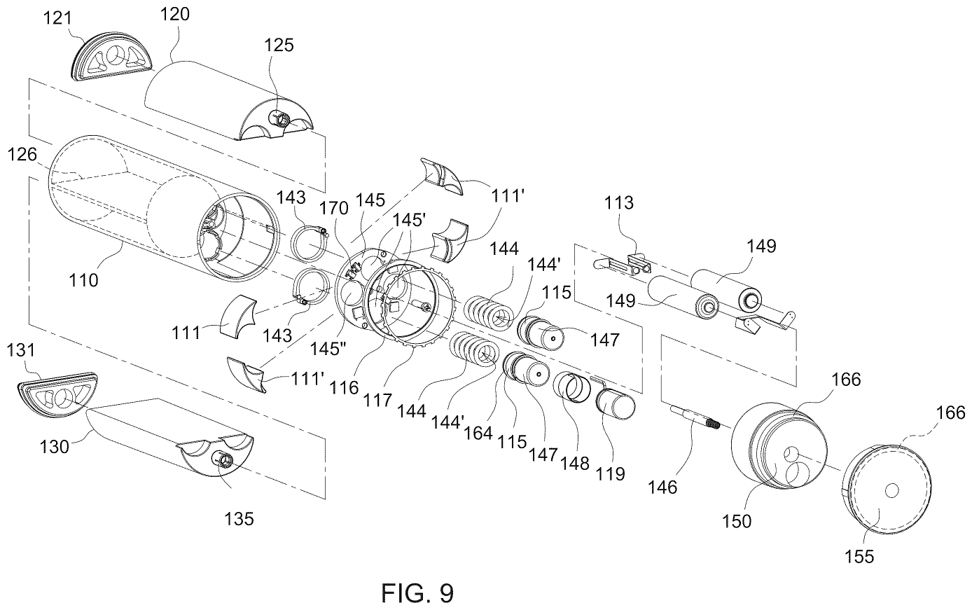

The electronic assembly 145 comprises at least one chamber aperture therethrough for each of the one or more chambers and at least one power aperture for each of one or more power sources. Referring to FIGS. 8A-8B and 9, in one embodiment, the electronic assembly 145 includes a chamber aperture 145′ for each of chambers 120 and 130. The electronic assembly 145 further includes a chamber aperture 145″ for each power source 149.

The at least one power source 149 is disposed between the one or more chambers 120, 130, and a second body end 114 of the casing body 110. Electrical connections (terminals) for the power source may be mounted in the casing body 110, such as on the respective chambers 120, 130, and in the shaped holder 150. In one embodiment, a terminal 113 is shown in FIG. 7.

The spring assembly 141 is disposed through the electronic assembly 145. The spring assembly 141 includes a spring 144 defining a gap 144′ therein, a spring mount 147, a clamping ring 143 disposed around a portion of the spring 144 and adapted to hold the spring 144 in a compressed state, and a heating element 118, coupled to the clamping ring. In one embodiment, an optional pin (not shown) may be used for sealing the clamping ring. If present the heating element 118 may be coupled to the pin or both the pin and clamping ring 143.

Referring to FIGS. 2, 5, and 7, a spring 144 defined a gap 144′ therein. The spring may be any suitable spring in the art. In the illustrated device in the figures, spring 144 is shown as a helical spring. The spring 144 may be disposed around a spring mount 147 disposed inside at least a portion of the gap 144′. The spring mount may be a metal, a plastic material, or both. FIG. 2 illustrates the spring 144 is a compressed state, and FIG. 5 illustrates the spring in a non-compressed state, such as after a release from the clamp. A spring mount 147 is disposed inside at least a portion of the gap 144′ and is disposed spaced from the driver 115.

Under mechanical operation, the spring 144 decompresses and pushes the driver 115 forward. The driver 115 in the driver recess 125 of a chamber 120 moves the chamber 120 in the casing body 110 and ejects the stopper 121. The now open-ended chamber 120 may dispense any chemical material contained therein. FIG. 2 illustrates the spring 144 is a compressed state with the stopper in the sealing position, and FIG. 5 illustrates the spring in a non-compressed state, such as after a release from the clamp, with the chamber 120 moved and the stopper 121 ejected from the chamber 120.

A clamping ring 143 is disposed around a portion of the spring 144 and is adapted to hold the spring 144 on the spring mount 147 in a compressed state.

The clamping ring 143 may be sealed by a number of sealing mechanisms. In one embodiment, a heating element 118 seals the clamping ring 143. In another embodiment, a pin seals the clamping ring. In a further embodiment, the pin seals the clamping ring 143 and is coupled to a heating element 118 that is disposed adjacent to and contacting the pin or is included with the pin in sealing the clamping ring 143. The heating element 118 may include a nichrome material, such as a nichrome wire. The nichrome wire is an alloy of nickel and chromium with high resistance to heat and corrosion, and suitable for use a heating element. The heating element 118 may also be designed to fracture when heated. The pin is preferably made of a plastic that is capable of deforming or fracturing under applied heat.

Referring to FIG. 8B, the heating element 118 is shown sealing the clamping ring 143 according to one embodiment.

In one embodiment, a capacitor holder 148 is disposed adjacent a spring mount 147 in the ejection device assembly 140. A capacitor 119 is disposed in the capacitor holder 148. The heating element 118 is coupled to the capacitor 119 and adapted to integrate into the electronic assembly 145 in a manner as to effectuate the release of the clamping ring 143 as described herein.

The spring assembly 141 and the ejection device assembly 140 are secured to the casing body 110 by the use of the mount 146. The mount 146 is positioned in the casing body using an aperture formed in the casing body support 161 and/or the chamber separator 126. One end of the mount 146 may include a securing surface, such as threaded screw surface for coupling with the shaped holder 150. The electronic assembly 145 may be positioned on the mount 146 with a mount aperture 146′ formed in the electronic assembly 145. A support ring 116 may be coupled to the electronic assembly 145 for supporting and positioning the electronic assembly 145 in the casing body 110. The mount may also be coupled to the shaped holder 150.

The components of the ejection device assembly 140 are disposed in a shaped holder 150. The shaped holder 150 is configured to hold components, such as the spring assembly 141, of the ejection device assembly 140. The shaped holder 150 may be made of a transparent or translucent material, such as a plastic material. A locking ring 117 may be coupled to the support ring 116 on the shaped holder 150 side of the support ring 116 for positioning within the shaped holder 150.

A protective seal 155 is disposed on and around a portion of the shaped holder 150 to seal the second body end 114 of the casing body 110. The protective seal 155 may be configured to cap or be screwed onto the shaped holder 150. The protective seal prevents fluids, such as air and water from entering the casing body 110. The protective seal 155 may be made of a metal or a plastic material. If a plastic material, the plastic material may be a transparent or translucent material. The protecting seal 155 may have grooves 155′ for receiving a support o-ring 166. The support o-ring 166 may be disposed between the casing body 110 and the protective seal 155. The support o-ring 166 may be used with the protective seal 155 to seal the device 100 from fluids.

Electrical devices 170 may be mounted in the ejection device assembly 140, such as on the electronic assembly 145. Suitable electrical devices include a microcontroller, a magnetic switch, a field effect transistor (FET), wireless communication components, LEDs, radio-frequency (RF) devices, resistors, timing crystals, capacitors, a heating element assembly, and sensors, and combinations thereof, among others.

In one embodiment, a microcontroller is disposed in the ejection device assembly 140 and coupled to the capacitor 119 and is electrically coupled to the one of the one or more power sources 149.

In one embodiment, a field effect transistor (FET) is disposed in the ejection device assembly 140 and coupled to the capacitor 119 and is electrically coupled to the one of the one or more power sources 149 and the microcontroller.

In one embodiment, a magnetic switch is disposed in the ejection device assembly 140 and coupled to the microcontroller. In one embodiment, the magnetic switch comprises a tunneling magnetoresistance effect (TMR) sensor switch to activate the device and is configured to start electronic timing circuitry on the microcontroller.

In one embodiment, a light-emitting diode (LED) is disposed in the ejection device assembly 140 and is electrically coupled to the one of the one or more power sources 149 and the microcontroller. The LED provides feedback when the device is activated. The LED is preferably positioned to be seen through the shaped holder 150 and/or protective seal 155.

In another embodiment, a radio-frequency (RF) device is disposed in the ejection device assembly 140 and is electrically coupled to the one of the one or more power sources 149 and the microcontroller and/or LED. In one embodiment, the RF device is a passive RF tag, such as an NFC tag (no batteries). The RF device can be used as an ID tag that will store information such as a unique ID, Product ID, Information on how many dispenses are on the device, timing interval information and active ingredient information.

In another embodiment, a sensor is disposed in the ejection device assembly 140 and is electrically coupled to the one of the one or more power sources 149 and the microcontroller and/or LED. The sensor may be configured to detect a state or action, to prevent the device from dispensing a chemical material prematurely, or to detect a state or action, to release a chemical material.

In one embodiment, the electrical devices 170 include a LED, a TMR switch, a FET for each heating element assembly, a microcontroller, resistors, timing crystal, a capacitor, and one or more heating element assemblies.

Embodiments of the present disclosure may include a wireless connection to the device for remote activation and/or treatment status. In one embodiment, the device includes a wireless connection component disposed in or on the casing body.

In one embodiment of operation, the method includes the following steps. The device is loaded by loading chemicals in the chambers, loading the chambers into the casing, and sealing the chambers with stoppers. The spring assembly is assembled to provide the spring under compression. The spring assembly is loaded into the device, and the proper electrical connections are established. The power supplies are provided to the device and the device is sealed and may be operational. Once sealed the device may be placed in an environment, such as a liquid environment.

Once in position, the device may be activated to eject the stopper and release any chemical material stored in one or more chambers. In one embodiment, the activation may include applying power to the heating element and releasing the clamping ring (by the methods described herein), decompressing the spring, contacting the second end of one of the one or more chambers with the spring, and ejecting the stopper from the first end of the one of the one or more chambers.

The device may be activated manually, timer, or by remote. In one embodiment, the device is activated using a wireless process. In another embodiment, the device is activated by a timer in the microprocessor (and the PCB circuitry) to allow timely dispersion of chemical materials without human interaction.

In another embodiment of operation, the spring is generally compressed during assembly, locked in place with a clamping ring and spring mount which is held closed (clamped) with a heating element, such as a nichrome wire or plastic pin. In some embodiments, the nichrome wire may be from 2 to 4 mm. When ready to release a spring (and fire a dose of medicine), the electronic circuitry charges a desired voltage, such as 3 volts, 4.5 volt, or 6 volts, to have a desired electrical capacitance, such as 1 Farad, 2 Farad or 2.5 Farad capacitor and once the capacitor is charged, the charge is released through a FET which activates the heating element, such as burning the nichrome wire like a fuse. When the nichrome fuse wire burns, the nichrome wire will break and in turn releases the clamping ring, releasing the piston/spring which pushes on the chamber ultimately ejecting the stopper. As an additional benefit, the nichrome wire can also heat up so quickly that the wire can melt the plastic on the clamping ring which also releases the clamping ring. This beneficially provides two ways to release the clamping ring in case the nichrome fuse does not occur, the melting of the plastic will also release the load.

Embodiments of the present disclosure include intricate design features for the purpose of making the device as small as possible, having maximum protection against leakage of ruminal fluid into the internal parts of the bolus and to make the device manufacturable.

Embodiments of the present disclosure may be used to dose animals with chemical materials including, and not limited to, oral vaccines, methane reduction compounds, and antibiotics, among others. Embodiments of the present disclosure may also be used for delivering slow-release large pills into cattle to reduce methane. Embodiments of the present disclosure may also be used to deliver vaccine boosters, for example at 28 days and six months. For example, embodiments of the present disclosure may be used to deliver booster doses of oral vaccines for any of a number of illnesses or conditions.

Embodiments of the present disclosure may include preloaded chambers or may include manufactured and supplied unloaded chamber void of any chemical materials, such as medicine. When unloaded, a producer would “load” the device with desired chemical materials, such as medicine.

Embodiments of the present disclosure may be disposed subcutaneously within the ruminant animal. Embodiments of the present disclosure may include a very small cylindrical implant that releases one or two treatments. For example, embodiments of the present disclosure may include a cylindrical device that is approximately 6 mm diameter and 30 mm in length. Such embodiments may be implanted with the same type of applicator as a cattle hormone implant.

Embodiments of the present disclosure may include the device 100 deployed in the field, either being administered to cattle or deployed in a storm drain catch basin. A permanent magnet (not shown) may be held up to the exterior casing body 110 of the device 100 near the electrical assembly 145 where a TMR magnetic switch is positioned. When the magnet is held in the correct position to trigger the TMR magnetic switch the internal LED will illuminate solid on. For example, when the magnet is held in this position for a period of three (or five) seconds the LED flashes, such as five times. Once the LED flashes five times the timing circuitry is activated on the microcontroller and electrical assembly 145. If the device 100 is factory programmed to release one chamber every 30 days, for example, the device 100 will count for the first 30 day period. At 30 days the electrical assembly 145 will initiate the release of the first chamber, such as chamber 120, by slowly charging the capacitor 119, for example, from about 3 to about 5 minutes. At the end of this charge cycle the capacitor 119 is instantly discharged via a FET which forces the current to flow from the charged capacitor 119 through the heating element 118, such as a nichrome wire, which in turn either fractures the heating element 118, or heats the heating element 118 sufficiently, such as heat deformation, to result in releasing the spring assembly. After this event the timing circuitry will begin timing for the second 30 day period, and continue doing so until all chambers are released.

It is believed that using our device, chemical and pharmaceutical manufacturers can effectively increase the duration of efficacy of their active ingredient or chemical without having to create new formulations and obtain new EPA and/or FDA approvals. For example, some products have efficacy for 30 days once the product is applied. In order to continue efficacy a person needs to apply follow-up treatments every 30 days. Some companies spend a lot of time and money to develop slow-release alternatives to increase the duration of efficacy for up to 90 days, for example, by using large slow release bricks or tablets. However it is difficult to control the rate of release of active ingredient with these products and the products can also be affected by environmental conditions. Additionally slow-release application of active ingredient is often not the preferred method of treatment. Full dose, periodic treatments are generally preferred.

The present embodiment is believed to increase the duration and/or efficacy of treatment by a multiple of the number of sealed chemical chambers. For example, with two chambers in a device 100, each chamber could be loaded with a treatment having 30 day efficacy. The device can release one compartment every 30 days effectively increasing the duration of efficacy by 2× (multiplied by the number of chemical chambers), or 8× for eight chambers.

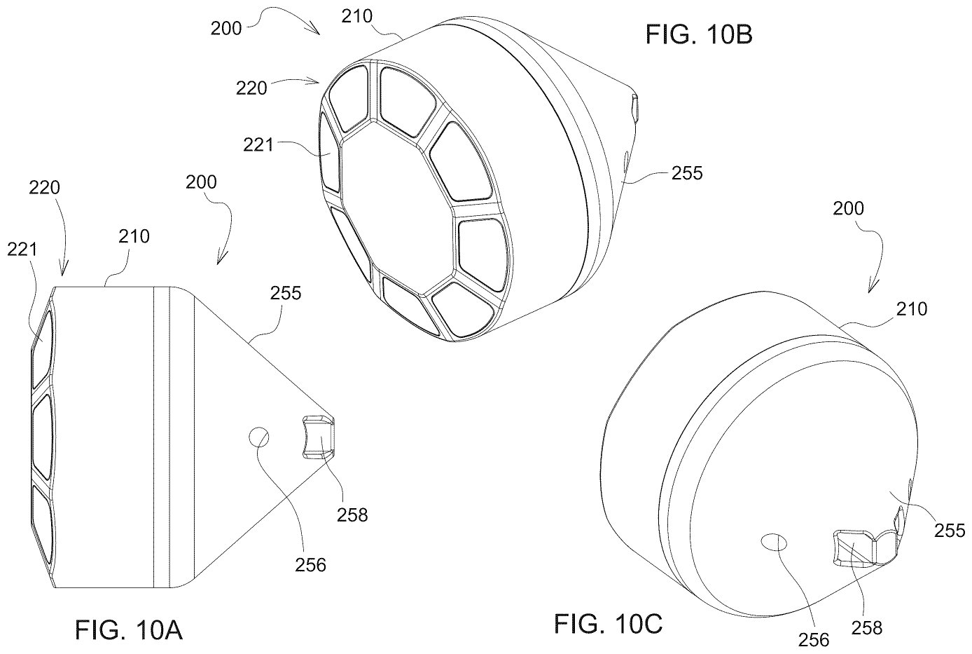

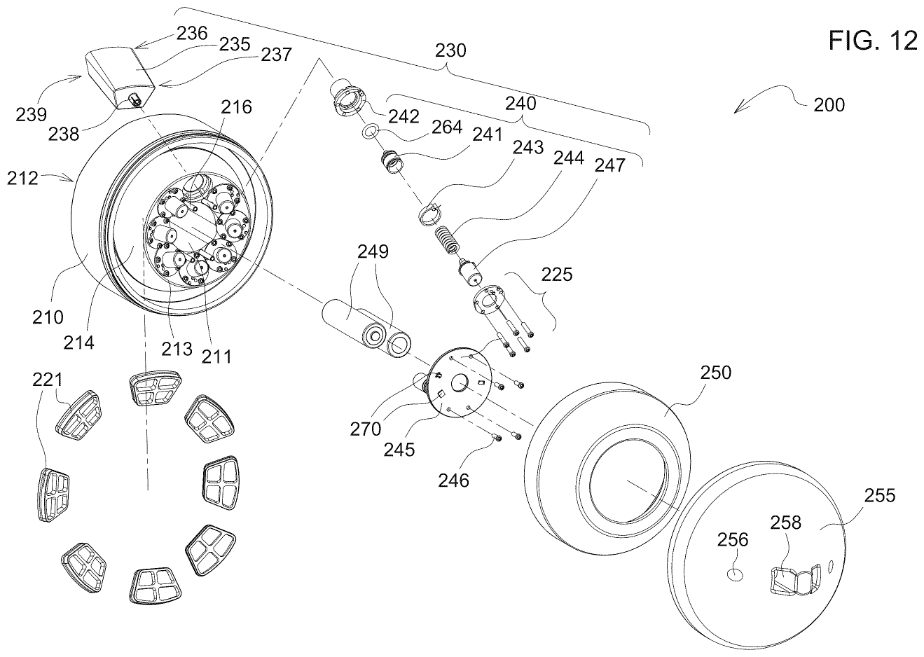

Another exemplary embodiment is shown in reference to FIGS. 10-14 using eight chambers, however, it is contemplated that different number of chambers may be used, and following description is provided for illustrative purposes.

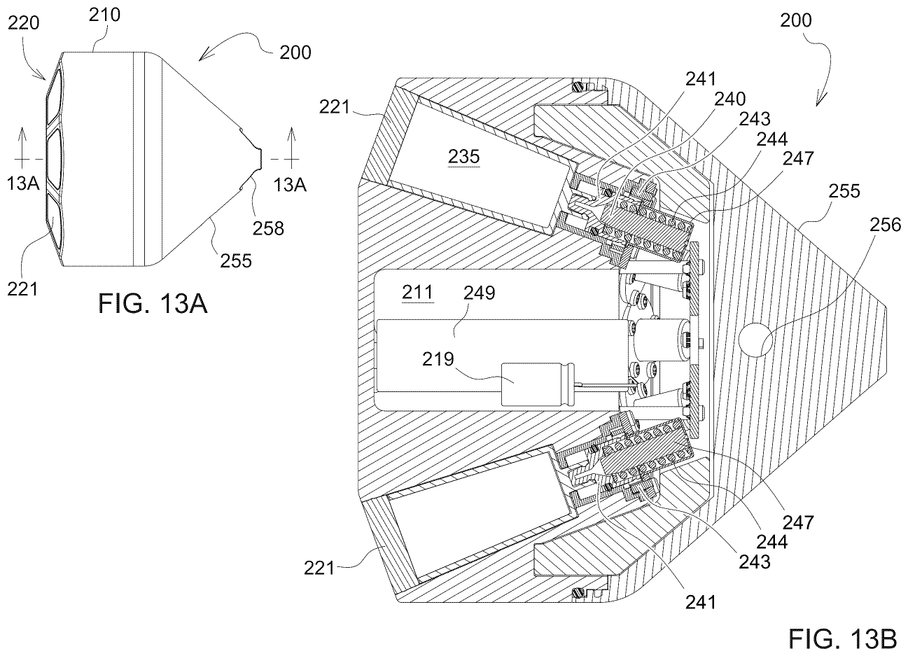

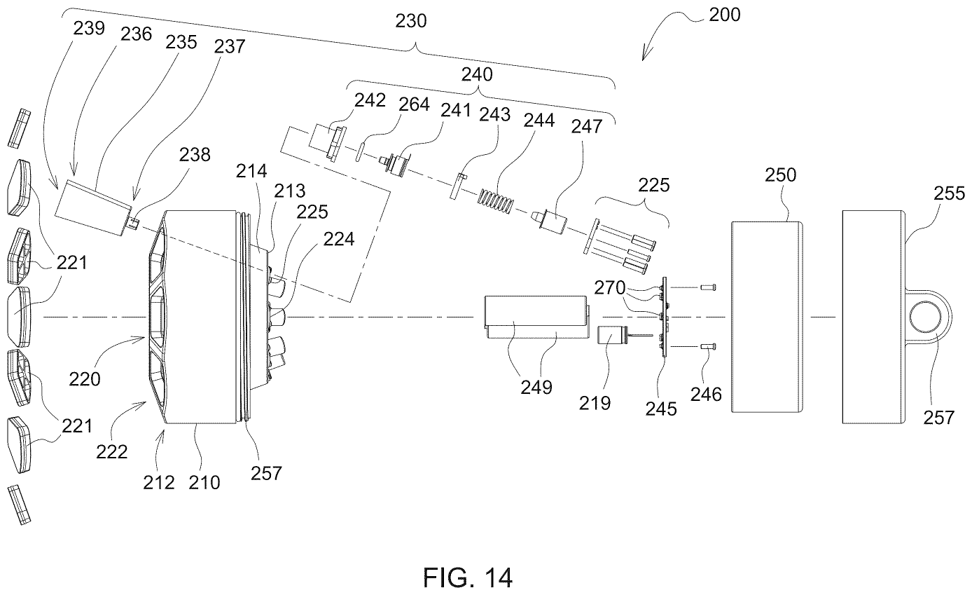

FIGS. 10A-10C and 13A show an exemplary embodiment of the device 200 in a closed position. In the closed position the device 200 may be sealed from fluid, such as air and water. In one embodiment, the sealed device may be considered waterproof. The sealed device 200 may be disposed in water as a submersible device.

The device 200 includes a housing 210, one or more apertures 220, one or more stoppers 221, and a sealing cap 255.

The housing 210 has a lower end 212 and an upper end 214. The housing 210 may be in the form of a cylinder or polyhedron, such as a annulus cylinder. Alternatively, the housing 210 may be in the form of any geometric shape as needed for application purposes, such as cones, cubes, cuboids, among others. The housing 210 may include a housing recess 211. Components may be disposed in the housing recess 211, such as power source 249, and capacitor 219.

The housing 210 may be made of a water-resistant and/or corrosion resistant material. Suitable housing materials may be selected from the group of plastic, metal, or combinations thereof. The housing 210 may be made of a transparent or translucent material.

The housing 210 has one or more apertures 220 disposed therethrough. Embodiments of the present disclosure may include one aperture or a plurality of apertures formed within a portion of the housing 210, for example, eight apertures are shown in FIGS. 10-14.

Each aperture 220 is disposed in the housing 210 in a parallel manner with a first aperture end 122 disposed toward or at the lower end 212 of the housing 210. The apertures 220 may be disposed at an angle in the housing 210, such as at an inward angle of 45° to 85° from the housing recess 211.

The apertures 220 may have a variety of cross-section shapes, such as a circle (forming a cylinder), trapezoid, square, semi-circular, and triangles among others. The apertures 220 may be of any geometric shape needed to be positioned inside the shape of the housing 210. The apertures 220 may also vary in size as needed to be positioned inside the shape of the housing 210. The apertures 220 may individually vary in size and shape based on the application of the device 200.

The apertures 220 are configured to hold an ejection device assembly 240 as described herein.

Each aperture 220 includes a lower end 222 and an upper end 224. A stopper 221 may be disposed in and sealing the lower end 222. The upper end 224 is disposed towards the upper end 214 of the housing 210. Each stopper 221 is configured to have the same cross-section as the apertures 220 in which it is disposed. Each stopper 221 is disposed in a manner with each stopper being ejectable under force using the ejection device assembly 240. Once a stopper 221 is removed or ejected from a chamber, any chemical material disposed in a chamber 235 coupled to the ejection device assembly 240 may be dispersed and/or ejected into the surrounding environment.

The housing 210 may optionally include a raised aperture encasement 213 in the upper end 214 of the housing 210. The aperture encasement 213 may be disposed around the housing recess 211. The aperture encasement 213 may be used for aligning components disposed in the apertures 220 of the system with other device components, such as the electronic assembly 245.

The housing may further include one or more mounts 216 extending from the upper end 214 of the housing 210. The one or more mounts 216 may be disposed on the raised aperture encasement 213 if present.

A sealing cap aperture 256 may be disposed in the sealing cap 255. A device, such as a string, rope, or chain, may be passed through the sealing cap aperture 256 to assist in mounting or securing the device 200 to a number of structures. For The sealing cap 255 may have a head recess 258 that may also be used to assist in mounting or securing the device 200 to a number of structures.

While removal of one of the stopper 221 may result in a fluid entering an aperture 220, the remaining device 200 is sealed from fluids. A sealed device allows the device 200 to be used in liquid environments for extended periods of time.

A chamber assembly 230 may be disposed in each of the one or more of the apertures 220. The chamber assembly 230 may comprise a chamber 235 and ejection device assembly 240. The chamber assembly 230 may be secured to the upper end 214 of the housing 210 by fasteners 225. When the chamber assembly 230 is secured, the chamber assembly 230 can be operated to eject the stopper 221 and remain within the aperture 220 of the housing 210. The prevents mechanical component loss.

The chamber 235 may be in the shape of the aperture 220 cross-section or other geometric shape that may be positioned inside the aperture 220. The chamber 235 may be a hollow chamber or may have shaped interiors. The chambers are configured to hold chemical materials, such as insecticides or other active chemical agents.

Each chamber includes a first chamber end 236 and a second chamber end 237. The first chamber end 236 comprises a partial or full opening, and a stopper 221 may be disposed in and sealing the opening. The second chamber end 237 is disposed towards an ejection device assembly 240. The second chamber end 237 includes a driver recess 238 to receive a driver 241 from the ejection device assembly 240.

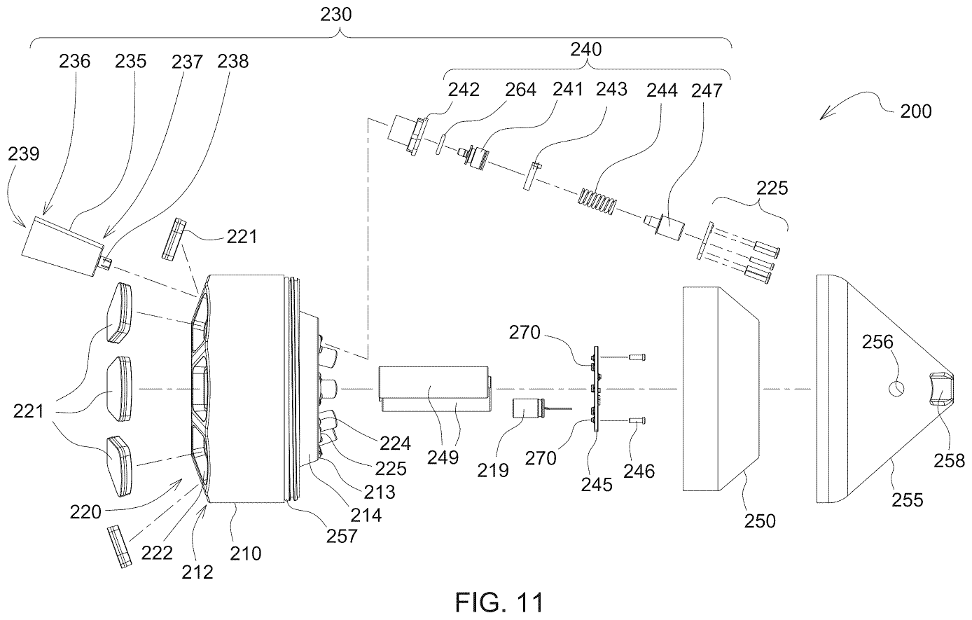

As shown in FIG. 11, a chamber 235 includes the first chamber end 236 comprises a partial or full opening 239 and a stopper 221 may be disposed in and sealing the opening 239. The stopper 221 is disposed in a manner with each stopper being ejectable under force using the ejection device assembly 240. Once a stopper 221 is removed or ejected from a chamber, any chemical material disposed in the chamber may be dispersed or ejected into the surrounding environment. FIG. 11 illustrates the device 200 with removed stopper 221 from chamber 235.

The second chamber end 124 is disposed towards the ejection device assembly 240. The second chamber end 237 comprises a driver recess 238 to receive a driver 241 from the ejection device assembly 240.

The ejection device assembly 240 is disposed adjacent the chamber 235 in the aperture 220. The ejection device assembly 240 includes chamber adapter 242, a driver 241 disposed in the chamber adapter 242 and coupled to the driver recess 238 of the chamber 235, a spring 244, and a spring mount 247.

Referring to FIGS. 11, 12, and 14, a spring 244 defines a gap 244′ therein. The spring 244 may be any suitable spring in the art. In the illustrated device in the figures, spring 244 is shown as a helical spring. The spring 244 may be disposed around a spring mount 247 disposed inside at least a portion of the gap 244′. The spring mount may be a metal, a plastic material, or both.

FIG. 13B illustrates the spring 244 is a compressed state

Under mechanical operation, the spring 244 decompresses and pushes the driver 241 forward. The driver 241 in the driver recess 238 of a chamber 235 moves the chamber 235 in the aperture 220 and ejects the stopper 121. The now open-ended chamber 235 may dispense any chemical material contained therein.

The chamber adapter 242 includes a clamping ring 243 adapted to be disposed around a portion of the spring and adapted to hold the spring in a compressed state, and a heating element 218, coupled to the clamping ring. In one embodiment, an optional pin (not shown) may be used for sealing the clamping ring. If present the heating element 218 may be coupled to the pin or both the pin and clamping ring 243.

The clamping ring 243 may be sealed by a number of sealing mechanisms. In one embodiment, a heating element 218 seals the clamping ring 243. In another embodiment, a pin seals the clamping ring 243. In a further embodiment, the pin seals the clamping ring 243 and is coupled to a heating element 218 that is disposed adjacent to and contacting the pin or is included with the pin in sealing the clamping ring 243. The heating element 218 may include a nichrome material, such as a nichrome wire. The nichrome wire is an alloy of nickel and chromium with high resistance to heat and corrosion, and suitable for use a heating element. The heating element 218 may also be designed to fracture when heated. The pin is preferably made of a plastic that is capable of deforming or fracturing under applied heat.

The ejection device assembly 240 may further include a driver o-ring 264, which may be used to help prevent fluids from entering the driver section and ejection device assembly 240, including electrical components, and may also secure the driver 241 in the ejection device assembly 240.

Each chamber assembly 230 is electrically coupled to an electronic assembly 245 through one or more electrical devices.

One or more mounting pins 246 may be disposed through the electronic assembly 245 and adapted for use with the one or mounts 216 to secure the electronic assembly 145 to the housing 210 and one or more of the chamber assemblies 230.

A capacitor 219 may be disposed in electrical communication with the electronic assembly 245. The capacitor 219 may be disposed in the housing recess 211.

Electrical devices 270 may be mounted in the ejection device assembly 140, such as on the electronic assembly 145. Suitable electrical devices include a microcontroller, a magnetic switch, a field effect transistor (FET), wireless communication components, LEDs, radio-frequency (RF) devices, resistors, timing crystals, capacitors, a heating element assembly, and sensors, and combinations thereof, among others.

In one embodiment, a microcontroller is disposed in the electronic assembly 245 and coupled to the capacitor 219 and is electrically coupled to the one of the one or more power sources 249. The power source 249 may be a battery or rechargeable battery. Embodiments of the present disclosure may include power sources, microcontroller IC's, among other electronic devices, that items may be changed in size or power to accommodate the necessary chambers (active chemical chambers).

In one embodiment, a field effect transistor (FET) is disposed in the electronic assembly 245 and coupled to the capacitor 219 and is electrically coupled to the one of the one or more power sources 249 and the microcontroller.

In one embodiment, a magnetic switch is disposed in the electronic assembly 245 and coupled to the microcontroller. In one embodiment, the magnetic switch comprises a tunneling magnetoresistance effect (TMR) sensor switch to activate the device and is configured to start electronic timing circuitry on the microcontroller.

In one embodiment, a light-emitting diode (LED) is disposed in the electronic assembly 245 and is electrically coupled to the one of the one or more power sources and the microcontroller. The LED provides feedback when the device is activated.

In another embodiment, a radio-frequency (RF) device is disposed in the electronic assembly 245 and is electrically coupled to the one of the one or more power sources 249 and the microcontroller and/or LED. In one embodiment, the RF device is a passive RF tag, such as an NFC tag (no batteries). The RF device can be used as an ID tag that will store information such as a unique ID, Product ID, Information on how many dispenses are on the device, timing interval information and active ingredient information.

In another embodiment, a sensor is disposed in the electronic assembly 245 and is electrically coupled to the one of the one or more power sources 249 and the microcontroller and/or LED. The sensor may be configured to detect a state or action, to prevent the device from dispensing a chemical material prematurely, or to detect a state or action, to release a chemical material. In one embodiment, the sensor is an accelerometer that will detect if the device is moving or not. For example, if the device is placed in a storm drain catch basin and it is raining really hard the device will be bouncing a bunch. In this case the sensor would prevent the device from dispensing until the water flow stopped so that the active ingredient is not released and washed away.

In one embodiment, the electrical devices 270 include a LED, a TMR switch, a FET for each heating element assembly 118, a microcontroller, resistors, timing crystal, a capacitor for each heating element assembly, and one or more heating element assembly.

Embodiments of the present disclosure may include a wireless connection to the device for remote activation and/or treatment status. In one embodiment, the device includes a wireless connection component disposed in or on the casing body

The device may further comprise a weight 250 to provide the desired buoyancy or to help stabilize the device in moving fluids. The weight 250 may comprise a metal. The weight 250 may be made from any suitable material, such as metal, that provide a desired weight for the device 200. Alternatively, if plastic or other light weight material is used instead of weight 250, a device 200 may instead have an inner cap in the shape of weight 250 to help seal the upper housing from fluids or damage in operation.

The sealing cap 255 is disposed over the weight 250 and is coupled to the housing 210. The sealing cap is coupled to the housing 210 in a manner to provide a sealed structure from fluids, such as air and water. In one embodiment, the sealed device may be waterproof. While removal of one of the stoppers 221 may result in a fluid entering a chamber 235 and/or aperture 220, the remaining device 200 is sealed from fluids. An o-ring 257 may be disposed between the housing 210 and the sealing cap 255 to help prevent fluids from entering the device 200. The sealed device allow the device 200 to be used in liquid environments for extended periods of time.

In one embodiment of operation, the method includes the following steps. The device 200 is loaded by loading chemicals in the chambers 235, loading the ejection device assembly 230 into the apertures 220, and sealing the apertures 220 with stoppers 221. The ejection device assembly 230 is assembled to provide the spring 244 under compression prior to loading the ejection device assembly 230. The proper electrical connections are established with the ejection device assembly. The power sources 249 are provided to the device 200 and the device 200 is sealed and may be operational. Once sealed the device 200 may be placed in an environment, such as a liquid environment.

Once in position, the device 200 may be activated to eject the stopper 221 and release any chemical material stored in one or more chambers 235. In one embodiment, the activation may include applying power to the heating element 218 and releasing the clamping ring (by the methods described herein), decompressing the spring 244, contacting the second end of one of the one or more chambers with the spring, and ejecting the stopper from the first end of the one of the one or more chambers. The release of any chemical material may also be by ejection from the force applied to the chamber 235 for ejection of the stopper 221.

The device 200 may be activated manually, timer, or by remote. In one embodiment, the device is activated using a wireless process. In another embodiment, the device is activated by a timer in the microprocessor to allow timely dispersion of chemical materials without human interaction.

In another embodiment of operation, the spring is generally compressed during assembly, locked in place with a clamping ring and spring mount which is held closed (clamped) with a heating element, such as a nichrome wire or plastic pin. In some embodiments, the nichrome wire may be from 2 to 4 mm. When ready to release a spring (and fire a dose of medicine), the electronic circuitry charges a desired voltage, such as 3 volts, 4.5 volt, or 6 volts, to have a desired electrical capacitance, such as 1 Farad, 2 Farad or 2.5 Farad capacitor and once the capacitor is charged, the charge is released through a FET which activates the heating element, such as burning the nichrome wire like a fuse. When the nichrome fuse wire burns, the nichrome wire will break and in turn releases the clamping ring, releasing the piston/spring which pushes on the chamber ultimately ejecting the stopper. As an additional benefit, the nichrome wire can also heat up so quickly that the wire can melt the plastic on the clamping ring which also releases the clamping ring. This beneficially provides two ways to release the clamping ring in case the nichrome fuse does not occur, the melting of the plastic will also release the load.

The size of the spring 244 or the size of the having element and clamping ring may be changed to accommodate different size dose (product) chambers.

Chemical materials may be disposed in the one or more chambers 235. The one or more chambers 235 may have the same or different chemical materials or amounts of chemical materials, thereby allowing for different applications as need by a user.

The chemical materials may be in the form of granules, liquids, oils, or slow-release products, among others. Examples of the forms of chemical materials include slow-release products, such as mosquito larvae control granules or liquids, or pesticides and/or insect attractant baits, such as for the New World screwworm. A commercial example of the mosquito larvae control granules or liquids include for example Summit's MOSQUITO DUNKS® products.

The chemical materials may include, and are not limited to, insecticides, such as larvicides and insect growth regulators, for example methoprene and pyriproxyfen, among others, using the device described herein. Examples of active ingredients for mosquito and other external parasite control that can be dispensed with the devices described herein include, but are not limited to, Bti (Bacillus thuringiensis israelensis), permethrin, resmethrin, sumithrin (d-phenothrin), malathion, Bs (Bacillus sphaericus), spinosyns, such as Spinosad, and temephos. Additionally, oils and surface films such as Monomolecular Films and Mineral Oils that create a thin film on water surfaces, suffocating mosquito larvae and pupae by disrupting their ability to breathe can be released from the devices described herein.

The device 200 may be configured for release of chemicals once per week, once per month, among other time increments, to provide automatic treatment over time.

Additionally, the device 200 may be configured for continual release of chemicals over hours, days, weeks, or months, among other time increments, to provide automatic treatment over time

The device 200 may be configured for dispensing over long periods of time. For example, the device may be configured for a three-month treatment period, a six-month period, and up to a one year treatment period.

While the figures illustrate an eight aperture device, the device may include one aperture or a plurality of apertures, such as two to fifty apertures, depending on the scale of the device. For example, the device may have three apertures for a smaller device, may have eight apertures as sown in the figures, may have ten (10) apertures for a medium size device, or up to fifty (50) or more apertures for larger devices. Each aperture may further include a chamber assembly as described herein.

Each chamber 235 may be preloaded with a chemical material, or the chamber 235 may be manufactured and supplied unloaded, void of any chemicals. When unloaded, a user would “load” the device with the desired chemicals.

Embodiments of the present disclosure may be disposed subcutaneously, in an animal, or submersible within a liquid, such as a body of water. Embodiments of the present disclosure may include a very small cylindrical implant that releases one or two treatments. For example, embodiments of the present disclosure may include a cylindrical device that is approximately 6 mm diameter and 30 mm in length.

Embodiments of the present disclosure may have one aperture in the device be much larger than other apertures. The larger aperture may contain a larger chamber 235 that may be utilized for a “shock” treatment when the device is first placed in the body of water.

In this case the “shock” treatment may be a different active ingredient, or not a slow-release ingredient, and would release an initial shock, such as when the parasite or larvae population is initially high. In the case of shock treatment of insecticides, the treatment would provide an immediate “knock down” of the larvae or parasite population and the other chambers of the device would be used as follow up maintenance treatments to keep the population low or under control. For example, when the device is first placed in the water it would release the first “shock” treatment at 5 minutes, followed by periodic maintenance treatments once per day, week or month.

Embodiments of the present disclosure include buoyancy regulatory components, such as weight 250. The device 200 could include a buoyancy regulatory component to keep the device 200 underwater. Alternatively, the device 200 could be modified to float on the surface of a liquid, for example, if the weight 250 is in fact a plastic sealing cap as described herein. Buoyancy of the devices may change after dispensing chemicals from the one or more chambers of the device.

In one embodiment one or more attachment components, such as a loop or hook, are disposed on the housing 210, such as on the bottom or side, the sealing cap 255, or both.

For example, Referring to FIG. 14, an attachment component 259 may be a loop or hook to attach both an anchor weight (to be used in environments where there is water flow) and/or a retrieval device, such as a rope, to retrieve the device 200 after it has completed its operational life.

Embodiments of the present disclosure include a device 200 that could also be developed to be deployed in small rivers or larger bodies of water. Such systems could be used to treat small rivers or larger bodies of water where there is danger of disease transmission such as River Blindness “Onchocerciasis”. The disease is caused by the parasitic worm Onchocerca volvulus and transmitted through the bites of infected blackflies that breed in fast-flowing rivers. In this case the device chambers would be loaded with an active ingredient such as ivermectin or albendazole that would be periodically released into the body of water.

Embodiments of the present disclosure include systems that could also be developed to be deployed in an agricultural setting, such as in the case of livestock water troughs and water tanks. In such troughs, the device can be used to control algae which can become toxic. Warm temperatures, sunlight and nutrients mixed together to create ideal conditions for algae growth. Also, algae and contaminants can affect the water taste potentially by reducing the amount of water intake by cattle (or livestock), which in turn impacts the health and performance of the animals. Some types of algae can poison cattle. Examples of active ingredients to control algae that can be loaded in the device are copper sulfate, hydrogen peroxide, vinegar or bleach. Other examples are commercially available water tank treatment chemicals or activated charcoal (sometimes used to absorb toxins in contaminated water), all of which could be released from the devices as described herein. Commercial examples of water tank treatment tablets include Airmax's STOCK TANK DEFENSE® tablets or Airmax's STOCK TANK SECRET™ tablets.

Embodiments of the present disclosure include systems that could be configured to periodically dispense probiotics or electrolytes into the water tank. The device could also be used to deliver IGR's (insect growth regulators) such as diflubenzuron that can be formulated as a feed through product that controls flies and ticks in cattle manure (it passes through the animal's system and resides in the cow manure that the flies feed on and consume the IGR).

Embodiments of the present disclosure include intricate design features for the purpose of making the device as small as possible, having maximum protection against leakage of ruminal fluid into the internal parts of the bolus and to make the device manufacturable.

Embodiments of the present disclosure beneficially provide: a dispensing system with precision timed release of product, eliminating the need for manually “re-treating” a body of water, the ability to load multiple times the volume of chemicals, much lower cost to manufacture (about 25% of the cost of the previous version) and much easier to manufacture/assemble and is designed for automated, volume assembly. In addition, embodiments of the present disclosure have about 10 times the amount of stopper ejection force compared to the prior devices making embodiments of the present disclosure far better suited to eject a stopper in a fluid environment. This technology is scalable and adaptable for submersible dispensing applications.

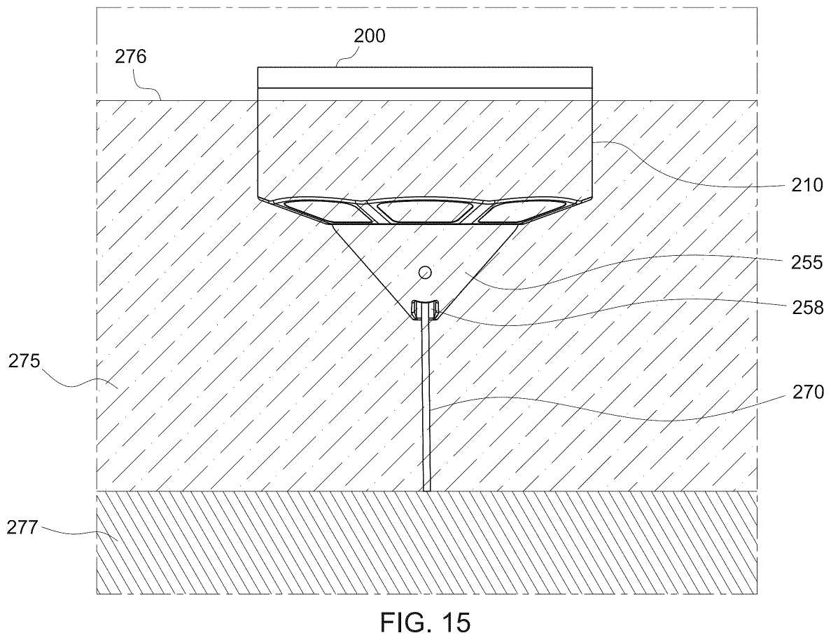

Other exemplary embodiments are shown in reference to FIGS. 15-18, and the following description is provided for illustrative purposes.

Referring to FIG. 15, the device 200 is illustrated to be partially (or fully) submersed in a fluid 275, such as water, while having sufficient buoyancy to have the apertures 220 of the device 200 above the surface 276 of a fluid 275 (or near the surface if the device is fully submersed). A securing device 270, such as a string or chain, is coupled to the head recess 258 for securing the device 200 to a bottom 277 of the fluid. Balancing the desired weight and/or changing the length of the securing device 270 can allow the device 200 to be position at any level in the fluid 275.

In operation, the device would eject a stopper and the chemicals would be released onto the surface or near the surface of the water, which is ideal for surface treatment application.

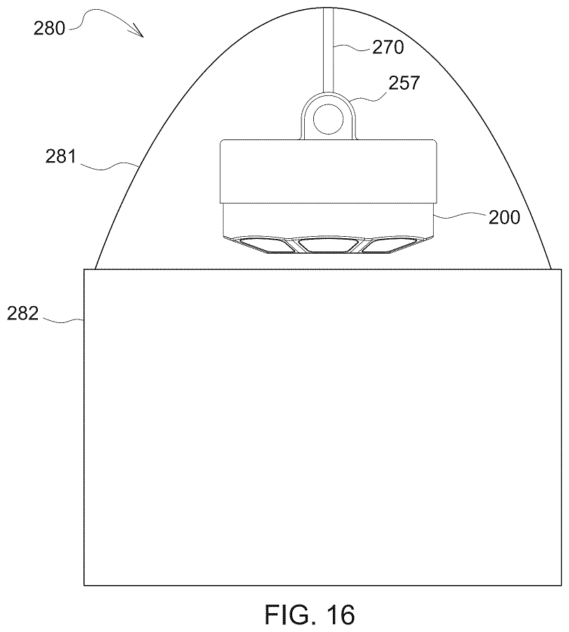

Referring to FIG. 16, the device 200 is illustrated for use in a insect bait trap. Insect bait traps generally comprise a bait trap housing 282 that insects fly into, and a bait trap chemical section 282 disposed on the bait trap housing 282. The bait trap chemical section 282 may comprise a dome of toped cylinder from which a chemical dispenser, such as device 200, may be secured for gravitationally dispensing chemicals into the bait trap housing 282 and/or the exterior environment. In one embodiment, the device 200 may use an attachment component 259 as shown in FIG. 14, for a securing device 270 to position the device 200 in the bait trap chemical section 284.

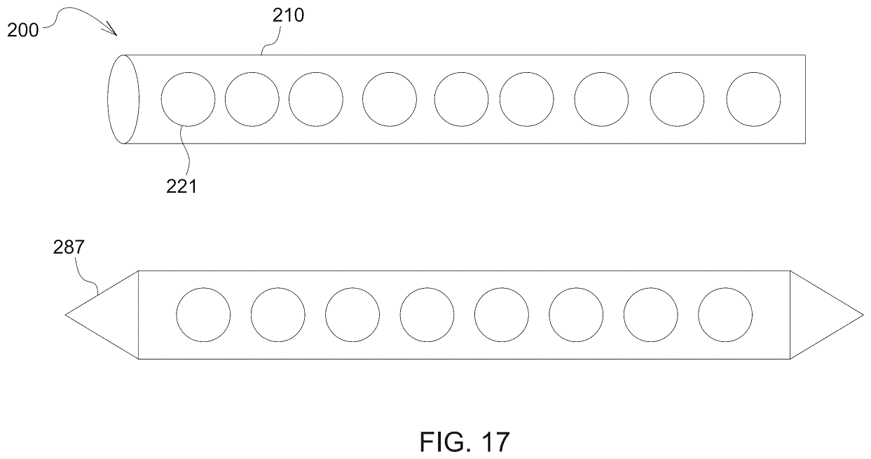

In another embodiment, the device 200 may be in the shape of a cylinder, with apertures 220 disposed therethrough and sealed with stopper 221 as shown in FIG. 17. A further embodiment of the device would include cones 287 on the ends of the cylinder for address water or air flow over the device 200.

The cylinder shaped device may be useful for applications, such as securing to a New World Screwworm trap or inserted into log decks between logs for insect control, needing devices with different configuration than FIGS. 10-14.

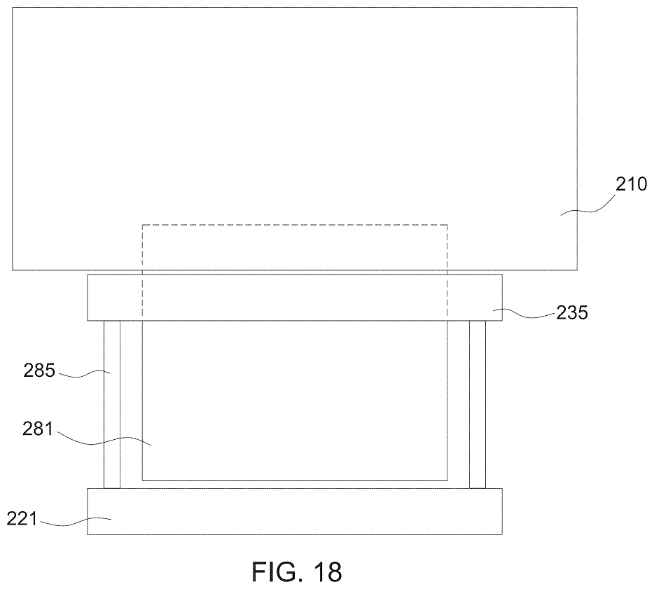

Referring to FIG. 18, the stopper 221 may be secured to the aperture 220 or chamber 235 in such a manner as to only be partially ejected during operation or allowing the stopper 221 to still be attached to the chamber assembly 235 or housing 210 after being ejected. The stopper 221 may be secured with a rigid tether 285 of different length and allowing for different distances of the stopper 221 from the chamber 235 following ejection. For example the rigid tether 285 may be only ejected a short distance from the chamber, allowing the chemical material 281 to be partially exposed to the environment.

Additionally, in some embodiments, the rigid tether 285 may allow for full exposure of the chemical material and the chemical material will still be maintained with the device 200. For example, the stopper is ejected sufficiently to fully exposed the chemical material and the upper side of the stopper forming a chemical holder.

The embodiments shown in FIG. 18 may be used with device 200 as described herein.

In the above description, details are set forth by way of example to facilitate an understanding of the disclosed subject matter. It should be apparent to a person of ordinary skill in the field, however, that the disclosed implementations are exemplary and not exhaustive of all possible implementations. Thus, it should be understood that reference to the described examples is not intended to limit the scope of the disclosure. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or processes described with respect to one implementation may be combined with the features, components, and/or processes described with respect to other implementations of the present disclosure. As used herein, the term “about” may refer to a +/−10% variation from the nominal value. It is to be understood that such a variation can be included in any value provided herein.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more operations or actions for achieving the described method. The method operations and/or actions may be interchanged with one another without departing from the scope of the claims. In other words, unless a specific order of operations or actions is specified, the order and/or use of specific operations and/or actions may be modified without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. An apparatus, comprising:
a housing having an upper end and a lower end;
one or more apertures disposed through the housing from the upper end to the lower end;
a stopper disposed at one or more of the lower ends of the one or more apertures; and
an ejection device assembly disposed in one or more of the one or more apertures adjacent the stopper, wherein each stopper being ejectable under force using each ejection device assembly.

2. The apparatus of claim 1, wherein the housing comprises a cylinder or a polyhedron, and further comprises a centrally disposed recess in the housing.

3. The apparatus of claim 2, further comprising an electronic assembly disposed at the upper end of the housing, and the electronic assembly contacts each ejection device assembly.

4. The apparatus of claim 3, further comprising one or more power sources disposed in the housing and coupled to the electronic assembly.

5. The apparatus of claim 1, wherein the one or more apertures are disposed in the housing in a circular ring and each aperture is spaced apart from another aperture.

6. The apparatus of claim 1, wherein each of the one or more apertures are disposed at an angle from 45° to 85° within the housing.

7. The apparatus of claim 1, wherein the ejection device assembly comprises:
a chamber having a driver recess;
a driver casing disposed around and exposing the driver recess;
a driver disposed within the driver casing and a portion of the driver is disposed in the driver recess;
a spring assembly disposed adjacent the driver, the spring assembly comprising:
a spring defining a gap therein; and
a spring mount disposed inside at least a portion of the gap,
wherein the driver is spaced from the spring mount.

8. The apparatus of claim 7, wherein the spring assembly further comprises:
a clamping ring disposed around a portion of the spring, and adapted to hold the spring in a compressed state;
a pin sealing the clamping ring; and
a heating element coupled to the pin.

9. The apparatus of claim 1, further comprising an inner sealing cap disposed on the upper end of the housing, the inner sealing cap adapted to have a shape between the one or more apertures and a perimeter or circumference of the housing, and inner sealing cap seals the one or more apertures.

10. The apparatus of claim 1, further comprising a sealing cap disposed on the upper end of the housing, the sealing cap having an upper end and a bottom end, and the bottom end is adapted to have a shape consistent within a perimeter or circumference of the housing.

11. The apparatus of claim 10, further comprising one or more apertures in the upper end of the outer sealing cap.

12. The apparatus of claim 11, wherein the outer sealing cap is in the shape of a cone, and the one or more apertures in the upper end of the outer sealing cap.

13. The apparatus of claim 11, wherein the outer sealing cap is in the shape of a cylinder with a mounting tab, and the one or more apertures are formed in the mounting tab.

14. The apparatus of claim 3, further comprising one or more electrical devices disposed in the electronic assembly and coupled to one or more power sources, the one or more electrical devices selected from the group consisting of a microcontroller, a magnetic switch, a field effect transistor (FET), wireless communication component, LED, radio-frequency device, a sensors, and combinations thereof.

15. The apparatus of claim 8, wherein the heating element comprises a nichrome wire.

16. A method for operating an apparatus, comprising:
providing a device comprising a housing having an upper end and a lower end, at least one aperture disposed through the housing from the upper end to the lower end, a stopper disposed at one or more of the lower ends of the at least one aperture, an ejection device assembly disposed in the at least one aperture adjacent the stopper, wherein each stopper being ejectable under force using each ejection device assembly, and an ejection device assembly comprising a chamber a spring assembly disposed adjacent the chamber, the spring assembly comprising at least a a spring defining a gap therein, a spring mount disposed inside at least a portion of the gap, a clamping ring disposed around a portion of the spring, and adapted to hold the spring in a compressed state and a heating element coupled to the clamping ring;
applying power to the heating element and releasing the clamping ring;
decompressing a compressed spring and the spring mount;
contacting the chamber with the spring mount; and
ejecting the stopper from the aperture.

17. The method of claim 16, wherein applying power to the heating element comprises charging a capacitor and releasing the charge through a FET to heat the heating element sufficiently to melt the heating element, melt a pin coupled to the heating element and sealing the clamping ring, or break the heating element.

18. The method of claim 16, further comprising activating a magnetic switch to activate the device, starting an electronic timing circuitry on a microcontroller, or both.

19. The method of claim 16, further comprising operating the device by a wireless connection, operating the device using a timer controlled by a microprocessor, or both.

20. A submersible dispensing system, comprising:
a cylindrical body; and
one or more chambers disposed within the cylindrical body, each of the one or more chambers containing a stopper at an end thereof, the stopper being ejectable under force using a spring assembly.
